(19) United States
(12) Patent Application Publication
(10) Pub. No.: US 2001/0044398 A1
(43) Pub. Date: Nov. 22, 2001

(54) Protease- and percarbonate-containing detergents

(76) Inventors: Horst-Dieter Speckmann, Langenfeld (DE); Joerg Poethkow, Duesseldorf (DE); Thomas Gassenmeier, Duesseldorf (DE); Peter Schmiedel, Duesseldorf (DE); Beatrix Kottwitz, Duesseldorf (DE)

Correspondence Address: Glenn E.J. Murphy, Henkel Corporation, Patent Law Dept., Suite 200, 2500 Renaissance Blvd., Gulph Mills, PA, 19406, US

(21) Appl. No.: 09/788,004

(22) Filed: Feb. 16, 2001

(30) Foreign Application Priority Data
Feb. 18, 2000 (DE) 100 07 608.4

(51) Int. Cl. C11D 3/386; C12S 9/00; C11D 9/42; C11D 3/00

(52) U.S. Cl. 510/305; 510/306; 510/309; 510/310; 510/320; 510/374; 510/375; 510/392; 510/530

(57) ABSTRACT

Detergents and cleaners having improved performance against protein-containing soils, containing a protease of the subtilisin type, in which—in at least one of positions 3, 4, 99, 188, 193, 199 and 211 (BLAP counting)—the amino acid present in that position in the wild-type protease is replaced by another amino acid, and coated particulate alkali metal percarbonate.

This application claims priority under 35 U.S.C. § 119 of DE 100 07 608.4, filed Feb. 18, 2000 in the German Patent Office.

### BACKGROUND OF THE INVENTION

This invention relates to enzyme-containing detergents which, besides typical ingredients, contain a genetically modified protease and a certain peroxidic bleaching agent.

Besides the ingredients essential to the washing process, such as surfactants and builders, detergents generally contain other ingredients which may be collectively referred to as washing aids and which comprise such different groups of ingredients as foam regulators, redeposition inhibitors, bleaching agents, bleach activators and dye transfer inhibitors. The washing aids in question also include substances which support cleaning performance through the enzymatic degradation of soils present on the fabric. The same also applies to detergents for cleaning hard surfaces. Besides the amylases which assist in removing starch-containing soils and the lipolytic lipases, particular significance attaches to the proteases.

Enzymes such as amylases, lipases and cellulases, but especially proteolytic enzymes, are widely used in detergents, washing aids and cleaners. Among the proteases, enzymes from the subtilisin family are exclusively used at the present time. These are extracellular proteins with a molecular weight of about 20,000 to 45,000. Subtilisins are relatively nonspecific enzymes which, besides their hydrolytic effect on peptide bonds, also have esterolytic properties (M. Bahn, R. D. Schmidt, Biotec 1, 119, 1987). Many representatives of the subtilisins are precisely characterized both physically and chemically. Their three-dimensional structure is often known in detail from X-ray structure analysis. The preconditions for molecular modeling and so-called protein engineering in the form of selective mutagenesis are thus in place (Kraut, Ann. Rev. Biochem. 46, 331-358, 1977). Genetic modifications of proteases have often been described; thus, as many as 219 protein variants of the subtilisins obtained by protein engineering were known in June, 1991 (A. Recktenwald et al., J. Biotechnol. 28, 1-23, 1993). Most of these variants were produced to improve the stability of the proteases.

A protease from the subtilisin family which is stable and active under strongly alkaline conditions can be produced in Bacillus lentus (DSM 5483) as described in International Patent Application WO 91102792. This Bacillus lentus alkaline protease (BLAP) can be produced by fermentation of Bacillus licheniformis transformed with an expression plasmid which carries the gene for BLAP under the control of the promoter from Bacillus licheniformis ATCC 53926. The composition and three-dimensional structure of BLAP are known (D. W. Godette et al., J. Mol. Biol. 228, 580-595, 1992). This protease is characterized by the sequence of 269 amino acids described in the literature, a calculated molecular weight of 26,823 dalton and a theoretical isoelectric point of 9.7. Variants of this Bacillus lentus DSM 5483 protease obtainable by mutation are described in U.S. Pat. No. 5,340,735. Included among these are protease enzymes which, in the washing—particularly repeated washing—of textiles of proteinogenic fibers, for example fabrics of silk or wool, cause minimal substance damage and destruction of the fiber structure without any loss of cleaning performance.

It has now surprisingly been found that the combination of a certain genetically modified protease with a certain peroxidic oxidizing agent leads to unexpected synergistic improvements in performance when it is used in detergents/cleaners.

### DESCRIPTION OF THE INVENTION

Accordingly, the present invention relates to a particulate protease- and percarbonate-containing detergent/cleaner which is characterized in that, besides typical ingredients compatible with such active substances, it contains a mutant of a protease of the subtilisin type, in which—in at least one of positions 3, 4, 99, 188, 193, 199 and 211 (BLAP counting)—the amino acid present in that position in the wild-type protease is exchanged for another amino acid, and particulate alkali metal percarbonate with a coating containing alkaline earth metal sulfate, alkali metal sulfate, alkali metal silicate, alkaline earth metal halide, alkali metal halide, alkali metal carbonate, alkali metal hydrogen carbonate, alkali metal phosphate, alkali metal borate, alkali metal perborate, boric acid, partly hydrated alumosilicate, carboxylic acid, dicarboxylic acid, polymer of unsaturated carboxylic and/or dicarboxylic acids or mixtures thereof.

Correspondingly coated alkali metal percarbonate particles are described in the prior art. Sodium percarbonate particles with a coating of 30% by weight to 75% by weight of alkali metal carbonate and 25% by weight to 70% by weight of alkali metal silicate are known from International patent application WO 99/64350. International patent application WO 96114389 discloses percarbonate particles coated with a combination of alkali metal silicate, a water-soluble magnesium salt, more particularly magnesium sulfate, and a chelating agent, more particularly a hydroxycarboxylic acid, corresponding particles coated with a hydroxycarboxylic acid and with a dicarboxylic acid being known respectively from International patent application WO 95/23210 and International patent application WO 95/23209. Percarbonate particles coated with a combination of boric acid and alkali metal halide, sulfate and/or nitrate and percarbonate particles coated with a combination of boric acid and alkali metal silicate are known respectively from International patent application WO 95/15292 and from European patent application EP 0 459 625. International patent application WO 95/15291 discloses a process for coating particulate sodium percarbonate with sodium hydrogen carbonate. A process for coating sodium percarbonate with polymers of unsaturated acids, more particularly copolymerization products of (meth)acrylic acid and maleic acid is known from International patent application WO 94/05594. Polycarboxylate-coated sodium percarbonate is also known from International patent application WO 22/17400. International patent application WO 93/20007 discloses sodium percarbonate coated with at least C₈ carboxylic acids and subsequently powdered with solids whereas sodium percarbonate coated with mixtures of carboxylic acids melting above and below 35° C. is known from International patent application WO 92/17404. A process for coating percarbonate with fatty acid alkali metal salts by application of the fatty acid salts in powder form is known from European patent application EP 0 503 516. Sodium percarbonate coated with mixtures of sodium carbonate and sodium chloride is known from European patent application EP 0 592 969. European patent application EP 0 546 815 discloses sodium percarbonate coated with alkali metal citrate.

Of these, particulate alkali metal percarbonates with coatings containing at least one of the inorganic salts mentioned, more particularly alkali metal sulfate and/or alkali metal silicate, are particularly preferred.

The ratio by weight of coating material to percarbonate in the coated alkali metal percarbonate particles is preferably in the range from 1:500 to 1:2 and more particularly in the range from 1:200 to 1:5.

In the prior art, coatings of the type in question have been applied in order to stabilize the percarbonate and hence to improve the bleaching performance of detergents/cleaners in which it is present. The combination of the percarbonate thus coated with the protease mentioned unforeseeably improves cleaning performance against protein-containing soils.

Accordingly, the present invention also relates to the use of a combination of a mutant of a protease of the subtilisin type, in which—in at least one of positions 3, 4, 99, 188, 193, 199 and 211 (BLAP counting)—the amino acid present in that position in the wild-type protease is exchanged for another amino acid, and particulate alkali metal percarbonate with a coating containing alkaline earth metal sulfate, alkali metal sulfate, alkali metal silicate, alkaline earth metal halide, alkali metal halide, alkali metal carbonate, alkali metal hydrogen carbonate, alkali metal phosphate, alkali metal borate, alkali metal perborate, boric acid, partly hydrated alumosilicate, carboxylic acid, dicarboxylic acid, polymer of unsaturated carboxylic and/or dicarboxylic acids or mixtures thereof for improving the cleaning performance of detergents/cleaners against protein-containing soils.

The above-mentioned protein-containing soils to be removed may be present on a textile surface or on a hard surface, for example a tile or a piece of crockery, depending on the nature of the detergent/cleaner. The use according to the invention is effected for the most part during the use of detergents/cleaners in washing/cleaning solutions, particularly water-containing washing/cleaning solutions.

A detergent/cleaner according to the invention preferably contains 3% by weight to 30% by weight and more particularly 7% by weight to 25% by weight of coated alkali metal percarbonate, sodium being the preferred alkali metal.

The detergent/cleaner according to the invention preferably has a proteolytic activity of about 100 PU/g to about 10,000 PU/g and, more particularly, 300 PU/g to 8,000 PU/g. The protease activity is measured by the following standardized method described in Tenside 7 (1970), 125: a solution containing 12 g/l casein and 30 mM sodium tripolyphosphate in water with a hardness of 15° dH (containing 0.058% by weight CaCl₂.2H₂O, 0.028% by weight MgCl₂.6H₂O and 0.042% by weight NaHCO₃) is heated to 70° C. and the pH value is adjusted to 8.5 by addition of 0.1 N NaOH at 50° C. 200 ml of a solution of the enzyme to be tested in 2% by weight sodium tripolyphosphate buffer solution (pH 8.5) are added to 600 ml of the substrate solution. The reaction mixture is incubated for 15 minutes at 50° C. The reaction is then terminated by addition of 500 ml TCA solution (0.44 M trichloroacetic acid and 0.22 M sodium acetate in 3% by volume acetic acid) and cooling (ice bath at 0° C., 15 minutes). The TCA-insoluble protein is removed by centrifugation. 900 ml of the supernatant phase are diluted with 300 ml of 2 N NaOH. The absorption of this solution at 290 nm is determined with an absorption spectrometer, the zero absorption value being determined by measuring the centrifuged solution which is prepared by mixing 600 ml of the above-mentioned TCA solution with 600 ml of the above-mentioned substrate solution and subsequently adding the enzyme solution. The proteolytic activity of a protease solution which produces an absorption of 0.500 OD under the described measuring conditions is defined as 10 PU (protease units) per ml.

Besides the Bacillus lentus protease genetically modified as described above, proteases suitable for use in accordance with the invention also include genetically modified proteases of the above-mentioned subtilisin type in which, in positions analogous to the above-mentioned positions in BLAP, exchanges of amino acid present in that position in the wild type protease for other amino acids have been made. Regarding the analogous positions in other subtilisin proteases, it is important to bear in mind that the numbering of the amino acid positions in BLAP differs from that of the frequently encountered subtilisin BPN′. The numbering of positions 1 to 35 is identical in subtilisin BPN′ and BLAP; through the absence of corresponding amino acids, positions 36 to 54 in BLAP correspond to positions 37 to 55 in BPN′. Similarly, positions 55 to 160 in BLAP correspond to positions 57 to 162 in BPN′ while positions 161 to 269 in BLAP correspond to positions 167 to 275 in BPN′.

Proteases preferably used in accordance with the invention include genetically modified proteases of the above-mentioned BLAP type in which—in position 211 (BLAP counting)—the amino acid leucine (L in the standard one-letter code) present in that position in the wild-type protease is exchanged for aspartic acid (D) or glutamic acid (E) (L211D or L211E). These proteases may be produced as described in International Patent Application WO 95/23221. Instead of or in addition to this, further modifications may have been made in relation to the original Bacillus lentus protease, such as for example at least one of the amino acid exchanges S3T, V4I, R99G, R99A, R99S, A188P, V193M and/or V199I. The use of a variant in which the amino acid exchanges S3T+V4I+V193M+V199I have been effected is particularly preferred.

The enzymes may be adsorbed onto support materials and/or encapsulated in membrane materials to protect them against premature inactivation, above all where they are to be used in particulate detergents/cleaners, as described, for example, in EP 0 564 476 or in International patent application WO 94/23005 for other enzymes. Other enzymes including, in particular, amylases, lipases and/or cellulases may be present in detergents/cleaners according to the invention by incorporation of the separate or separately made-up enzymes or by incorporation of protease and other enzyme made-up together in the same granules, as known for example from International patent application WO 96/00772 or WO 96/00773.

Besides the combination used in accordance with the invention, the detergents/cleaners according to the invention—which may be present as, in particular, powder-form solids, as post-compacted particles or as homogeneous solutions or suspensions—may in principle contain any known ingredients typically encountered in detergents. More particularly, the detergents according to the invention may contain builders, surfactants, additional bleaching agents based on organic and/or inorganic peroxygen compounds, bleach activators, water-miscible organic solvents, additional enzymes, sequestering agents, electrolytes, pH regulators and other auxiliaries, such as optical brighteners, redeposition inhibitors, dye transfer inhibitors, foam regulators, silver corrosion inhibitors and dyes and perfumes.

The detergents according to the invention may contain one or more surfactants, more particularly anionic surfactants, nonionic surfactants and mixtures thereof, but also cationic, zwitterionic and amphoteric surfactants.

Suitable anionic surfactants are in particular soaps and those containing sulfate or sulfonate groups. Suitable surfactants of the sulfonate type are preferably C₉₋₁₃ alkyl benzenesulfonates, olefin sulfonates, i.e. mixtures of alkene and hydroxyalkane sulfonates, and the disulfonates obtained, for example, from C₁₂₋₁₈ monoolefins with an internal or terminal double bond by sulfonation with gaseous sulfur trioxide and subsequent alkaline or acidic hydrolysis of the sulfonation products. Other suitable surfactants of the sulfonate type are the alkane sulfonates obtained from C₁₂₋₁₈ alkanes, for example by sulfochlorination or sulfoxidation and subsequent hydrolysis or neutralization. The esters of α-sulfofatty acids (ester sulfonates), for example the α-sulfonated methyl esters of hydrogenated coconut oil, palm kernel oil or tallow fatty acids, which are obtained by α-sulfonation of the methyl esters of fatty acids of vegetable and/or animal origin containing 8 to 20 carbon atoms in the fatty acid molecule and subsequent neutralization to water-soluble monosalts are also suitable. The esters in question are preferably the α-sulfonated esters of hydrogenated coconut oil fatty acid, palm oil fatty acid, palm kernel oil fatty acid or tallow fatty acids, although sulfonation products of unsaturated fatty acids, for example oleic acid, may also be present in small quantities, preferably in quantities of not more than about 2 to 3% by weight. α-Sulfofatty acid alkyl esters with an alkyl chain of not more than 4 carbon atoms in the ester group, for example methyl esters, ethyl esters, propyl esters and butyl esters, are particularly preferred. The methyl esters of α-sulfofatty acids (MES) and saponified disalts thereof are used with particular advantage. Other suitable anionic surfactants are sulfonated fatty acid glycerol esters, i.e. the monoesters, diesters and triesters and mixtures thereof which are obtained where production is carried out by esterification of a monoglycerol with 1 to 3 moles of fatty acid or in the transesterification of triglycerides with 0.3 to 2 moles of glycerol. Preferred alk(en)yl sulfates are the alkali metal salts and, in particular, the sodium salts of the sulfuric acid semiesters of C₁₂₋₁₈ fatty alcohols, for example cocofatty alcohol, tallow fatty alcohol, lauryl, myristyl, cetyl or stearyl alcohol, or C₁₀₋₂₀ oxoalcohols and the corresponding semiesters of secondary alcohols with the same chain length. Other preferred alk(en)yl sulfates are those with the chain length mentioned which contain a synthetic, linear alkyl chain based on a petrochemical and which are similar in their degradation behavior to the corresponding compounds based on oleochemical raw materials. C₁₂₋₁₆ alkyl sulfates and C₁₂₋₁₅ alkyl sulfates and also C₁₄₋₁₅ alkyl sulfates alkyl sulfates are particularly preferred from the washing performance point of view. Other suitable anionic surfactants are 2,3-alkyl sulfates which may be produced, for example, in accordance with U.S. Pat. No. 3,234,258 or U.S. Pat. No. 5,075,041 and which are commercially obtainable as products of the Shell Oil Company under the name of DAN®. The sulfuric acid monoesters of linear or branched C₇₋₂₁ alcohols ethoxylated with 1 to 6 moles of ethylene oxide, such as 2-methyl-branched C₉₋₁₁ alcohols containing on average 3.5 moles of ethylene oxide (EO) or C₁₂₋₁₈ fatty alcohols containing 1 to 4 EO, are also suitable. In view of their high foaming capacity, they are normally used in only relatively small quantities, for example in quantities of 1 to 5% by weight, in laundry detergents. Other preferred anionic surfactants are the salts of alkyl sulfosuccinic acid which are also known as sulfosuccinates or as sulfosuccinic acid esters and which represent monoesters and/or diesters of sulfosuccinic acid with alcohols, preferably fatty alcohols and, more particularly, ethoxylated fatty alcohols. Preferred sulfosuccinates contain C₈₋₁₈ fatty alcohol molecules or mixtures thereof. Particularly preferred sulfosuccinates contain a fatty alcohol molecule derived from ethoxylated fatty alcohols which, considered in isolation, represent nonionic surfactants. Of these sulfosuccinates, those of which the fatty alcohol molecules are derived from narrow-range ethoxylated fatty alcohols are particularly preferred. Alk(en)yl succinic acid preferably containing 8 to 18 carbon atoms in the alk(en)yl chain or salts thereof may also be used. Other suitable anionic surfactants are fatty acid derivatives of amino acids, for example of N-methyl taurine (taurides) and/or of N-methyl glycine (sarcosides). The sarcosides or rather sarcosinates, above all sarcosinates of higher and optionally mono- or poly-unsaturated fatty acids, such as oleyl sarcosinate, are particularly preferred. Other suitable anionic surfactants are, in particular, soaps. Suitable soaps are, in particular, saturated fatty acid soaps, such as the salts of lauric acid, myristic acid, palmitic acid, stearic acid, hydrogenated erucic acid and behenic acid, and soap mixtures derived in particular from natural fatty acids, for example coconut oil, palm kernel oil or tallow fatty acids. The known alkenyl succinic acid salts may be used together with or as a substitute for soaps.

The anionic surfactants, including the soaps, may be present in the form of their sodium, potassium or ammonium salts and as soluble salts of organic bases, such as mono-, di- or triethanolamine. The anionic surfactants are preferably present in the form of their sodium or potassium salts and, more preferably, in the form of their sodium salts.

Suitable nonionic surfactants are, in particular, alkyl glycosides and ethoxylation and/or propoxylation products of alkyl glycosides or linear or branched alcohols containing 12 to 18 carbon atoms in the alkyl moiety and 3 to 20 and preferably 4 to 10 alkyl ether groups. Corresponding ethoxylation and/or propoxylation products of N-alkylamines, vicinal diols, fatty acid esters and fatty acid amides, which correspond to the long-chain alcohol derivatives mentioned in regard to the alkyl moiety, and of alkylphenols containing 5 to 12 carbon atoms in the alkyl moiety, may also be used.

Preferred nonionic surfactants are alkoxylated, advantageously ethoxylated, more particularly primary alcohols preferably containing 8 to 18 carbon atoms and an average of 1 to 12 moles of ethylene oxide (EO) per mole of alcohol, in which the alcohol radical may be linear or, preferably, 2-methyl-branched or may contain linear and methyl-branched radicals in the form of the mixtures typically present in oxoalcohol radicals. However, alcohol ethoxylates containing linear radicals of alcohols of native origin with 12 to 18 carbon atoms, for example coconut oil fatty alcohol, palm oil fatty alcohol, tallow fatty alcohol or oleyl alcohol, and an average of 2 to 8 EO per mole of alcohol are particularly preferred. Preferred ethoxylated alcohols include, for example, C₁₂₋₁₄ alcohols containing 3 EO or 4 EO, C₉₋₁₁ alcohols containing 7 EO, C₁₃₋₁₅ alcohols containing 3 EO, 5 EO, 7 EO or 8 EO, C₁₂₋₁₈ alcohols containing 3 EO, 5 EO or 7 EO and mixtures thereof, such as mixtures of C₁₂₋₁₄ alcohol containing 3 EO and C₁₂₋₁₈ alcohol containing 7 EO. The degrees of ethoxylation mentioned are statistical mean values which, for a special product, may be either a whole number or a broken number. Preferred alcohol ethoxylates have a narrow homolog distribution (narrow range ethoxylates, NRE). In addition to these nonionic surfactants, fatty alcohols containing more than 12 EO may also be used, as described above. Examples of such fatty alcohols are (tallow) fatty alcohols containing 14 EO, 16EO, 20EO, 25 EO, 30 EO or 40 EO. Extremely low-foaming compounds are normally used, above all in dishwasher detergents. Such compounds preferably include C₁₂₋₁₈ alkyl polyethylene glycol/polypropyene glycol ethers containing up to 8 moles ethylene oxide and up to 8 moles propylene oxide units in the molecule. However, other known low-foaming nonionic surfactants such as, for example, C₁₂₋₁₈ alkyl polyethylene glycol/polybutylene glycol ethers containing up to 8 moles ethylene oxide and up to 8 moles butylene oxide units in the molecule and end-capped alkyl polyalkylene glycol mixed ethers may also be used. The hydroxyl-containing alkoxylated alcohols described in European patent application EP 0 300 305, so-called hydroxy mixed ethers, are also particularly preferred. The nonionic surfactants also include alkyl glycosides with the general formula RO(G)X where R is a primary, linear or methyl-branched, more particularly 2-methyl-branched, aliphatic radical containing 8 to 22 and preferably 12 to 18 carbon atoms and G is a glycose unit containing 5 or 6 carbon atoms, preferably glucose. The degree of oligomerization x, which indicates the distribution of mono- and oligoglycosides, is a number (which, as an analytically determined quantity, may also be a broken number) of 1 to 10; preferably x=1.2 to 1.4. Other suitable surfactants are polyhydroxyfatty acid amides corresponding to formula (I):

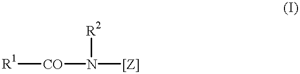

in which R¹CO is an aliphatic acyl group containing 6 to 22 carbon atoms, R² is hydrogen, an alkyl or hydroxyalkyl group containing 1 to 4 carbon atoms and [Z] is a linear or branched polyhydroxyalkyl group containing 3 to 10 carbon atoms and 3 to 10 hydroxyl groups. The polyhydroxyfatty acid amides are preferably derived from reducing sugars containing 5 or 6 carbon atoms, more particularly from glucose. The group of polyhydroxy-fatty acid amides also includes compounds corresponding to formula (II):

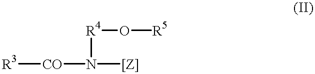

in which R³ is a linear or branched alkyl or alkenyl group containing 7 to 12 carbon atoms, R⁴ is a linear, branched or cyclic alkylene group or an arylene group containing 2 to 8 carbon atoms and R⁵ is a linear, branched or cyclic alkyl group or an aryl group or a hydroxyalkyl group containing 1 to 8 carbon atoms, C₁4 alkyl or phenyl groups being preferred, and [Z] is a linear polyhydroxyalkyl group, of which the alkyl chain is substituted by at least two hydroxyl groups, or alkoxylated, preferably ethoxylated or propoxylated, derivatives of such a group. Again, [Z] is preferably obtained by reductive amination of a sugar, for example glucose, fructose, maltose, lactose, galactose, mannose or xylose. The N-alkoxy or N-aryloxy-substituted compounds may then be converted into the required polyhydroxyfatty acid amides by reaction with fatty acid methyl esters in the presence of an alkoxide as catalyst, for example in accordance with the teaching of International patent application WO 95/07331. Another class of preferred nonionic surfactants which are used either as sole nonionic surfactant or in combination with other nonionic surfactants, particularly together with alkoxylated fatty alcohols and/or alkyl glycosides, are alkoxylated, preferably ethoxylated or ethoxylated and propoxylated, fatty acid alkyl esters preferably containing 1 to 4 carbon atoms in the alkyl chain, more particularly the fatty acid methyl esters which are described, for example, in Japanese patent application JP 581217598 or which are preferably produced by the process described in International patent application WO 90/13533. Nonionic surfactants of the amine oxide type, for example N-cocoalkyl-N,N-dimethylamine oxide and N-tallowalkyl-N,N-dihydroxyethyl amine oxide, and the fatty acid alkanolamide type are also suitable. The quantity in which these nonionic surfactants are used is preferably no more, in particular no more than half, the quantity of ethoxylated fatty alcohols used. Other suitable surfactants are so-called gemini surfactants. Gemini surfactants are generally understood to be compounds which contain two hydrophilic groups per molecule. These groups are generally separated from one another by a so-called “spacer”. The spacer is generally a carbon chain which should be long enough for the hydrophilic groups to have a sufficient spacing to be able to act independently of one another. Gemini surfactants are generally distinguished by an unusually low critical micelle concentration and by an ability to reduce the surface tension of water to a considerable extent. In exceptional cases, however, gemini surfactants are not only understood to be “dimeric” surfactants, but also “trimeric” surfactants. Suitable gemini surfactants are, for example, the sulfated hydroxy mixed ethers according to German patent application DE 43 21 022 and the dimer alcohol bis- and trimer alcohol tris-sulfates and -ether sulfates according to earlier German patent application DE 195 03 061. The end-capped dimeric and trimeric mixed ethers according to earlier German patent application DE 195 13 391 are distinguished in particular by their bifunctionality and multifunctionality. Thus, the end-capped surfactants mentioned exhibit good wetting properties and are low-foaming so that they are particularly suitable for use in machine washing or cleaning processes. However, the gemini polyhydroxyfatty amides or poly-polyhydroxyfatty acid amides described in International patent applications WO 95/19953, WO 95/19954 and WO 95/19955 may also be used.

Surfactants are present in laundry detergents according to the invention in quantities of preferably 5% by weight to 50% by weight and more preferably 8% by weight to 30% by weight whereas compositions for cleaning hard surfaces, more particularly for machine dishwashing, have lower surfactant contents of up to 10% by weight, preferably up to 5% by weight and more preferably in the range from 0.5% by weight to 3% by weight.

A laundry detergent according to the invention contains at least one water-soluble and/or water-insoluble, organic and/or inorganic builder. Suitable water-soluble organic builders include polycarboxylic acids, more particularly citric acid and sugar acids, monomeric and polymeric aminopolycarboxylic acids, more particularly methyl glycine diacetic acid, nitrilotriacetic acid and ethylenediamine tetraacetic acid and polyaspartic acid, polyphosphonic acids, more especially aminotris(methylene phosphonic acid), ethylenediamine tetrakis(methylene phosphonic acid) and 1-hydroxyethane-1,1-diphosphonic acid, and polymeric (poly)carboxylic acids, more particularly the polycarboxylates obtainable by oxidation of polysaccharides or dextrins according to International patent application WO 93116110 or International patent application WO 92118542 or European patent EP 0 232 202, polymeric acrylic acids, methacrylic acids, maleic acids and copolymers thereof which may also contain small amounts of polymerizable substances with no carboxylic acid functionality in copolymerized form. The relative molecular weight of the homopolymers of unsaturated carboxylic acids is generally between 5,000 and 200,000 while the relative molecular weight of the copolymers is between 2,000 and 200,000 and preferably between 50,000 and 120,000 based on free acid. A particularly preferred acrylic acid/maleic acid copolymer has a relative molecular weight of 50,000 to 100,000. Commercial products are, for example, Sokalan®E CP 5, CP 10 and PA 30 of BASF. Suitable, but less preferred, compounds of this class are copolymers of acrylic acid or methacrylic acid with vinyl ethers, such as vinyl methyl ethers, vinyl esters, ethylene, propylene and styrene, in which the acid makes up at least 50% by weight. Other suitable water-soluble organic builders are terpolymers which contain two unsaturated acids and/or salts thereof as monomers and vinyl alcohol and/or an esterified vinyl alcohol or a carbohydrate as the third monomer. The first acidic monomer or its salt is derived from a monoethylenically unsaturated C₃₋₈ carboxylic acid and preferably from a C₃₋₄ monocarboxylic acid, more especially (meth)acrylic acid. The second acidic monomer or its salt may be a derivative of a C₄₋₈ dicarboxylic acid, maleic acid being particularly preferred, and/or a derivative of an allylsulfonic acid substituted in the 2-position by an alkyl or aryl group. Polymers such as these can be produced in particular by the processes described in German patents DE 42 21 381 and German patent application DE 43 00 772 and generally have a relative molecular weight of 1,000 to 200,000. Other preferred copolymers are the copolymers which are described in German patent applications DE 43 03 320 and DE 44 17 734 and which preferably contain acrolein and acrylic acid/acrylic acid salts or vinyl acetate as monomers. The organic builders may advantageously be used in the form of aqueous solution, preferably in the form of 30 to 50% by weight aqueous solutions, particularly for the production of liquid detergents. All the acids mentioned are generally used in the form of their water-soluble salts, more especially their alkali metal salts.

If desired, organic builders of the type in question may be present in quantities of up to 40% by weight, preferably in quantities of up to 25% by weight and more preferably in quantities of 1% by weight to 8% by weight. Quantities near the upper limit are preferably used in paste-form or liquid, more particularly water-containing detergents.

Suitable water-soluble inorganic builders are, in particular, alkali metal silicates and polymeric alkali metal phosphates which may be present in the form of their alkaline, neutral or acidic sodium or potassium salts. Examples of such builders are trisodium phosphate, tetrasodium diphosphate, disodium dihydrogen diphosphate, pentasodium triphosphate, so-called sodium hexametaphosphate and the corresponding potassium salts or mixtures of sodium and potassium salts. Crystalline or amorphous alkali metal alumosilicates in quantities of up to 50% by weight and preferably not more than 40% by weight and, in liquid detergents in particular, in quantities of 1 to 5% by weight are used as water-insoluble, water-dispersible inorganic builder materials. Of these inorganic builders, crystalline sodium alumosilicates in detergent quality, more particularly zeolite A, P and optionally X, individuall or in the form of mixtures, for example in the form of a co-crystallizate of the zeolites A and X (Vegobond® AX, a product of Condea Augusta S.P.A.), are preferred. Quantities near the upper limit mentioned are preferably used in solid particulate detergents. Suitable alumosilicates contain no particles larger than 30 μm in size, at least 80% by weight preferably consisting of particles smaller than 10 μm in size. Their calcium binding capacity, which may be determined in accordance with German patent DE 24 12 837, is generally in the range from 100 to 200 mg CaO per gram.

Suitable substitutes or partial substitutes for the alumosilicate mentioned are crystalline alkali metal silicates which may be present either on their own or in the form of a mixture with amorphous silicates. The alkali metal silicates suitable as builders in the surfactant mixtures according to the invention preferably have a molar ratio of alkali metal oxide to SiO₂ of less than 0.95:1 and, more particularly, in the range from 1:1.1 to 1:12 and may be amorphous or crystalline. Preferred alkali metal silicates are sodium silicates, more especially amorphous sodium silicates, with a molar Na₂O:SiO₂ ratio of 1:2 to 1:2.8. Those with a molar Na₂O:SiO₂ ratio of 1:1.9 to 1:2.8 can be produced by the method according to European patent application EP 0 425 427. Crystalline layered silicates with the general formula Na₂SiₓO₂ₓ₊₁.yH₂O, in which x—the so-called modulus—is a number of 1.9 to 4 and y is a number of 0 to 20, preferred values for x being 2, 3 or 4, are preferably used as crystalline silicates which may be present either on their own or in admixture with amorphous silicates. Crystalline layered silicates which correspond to this general formula are described, for example, in European patent application EP 0 164 514. Preferred crystalline layered silicates are those in which x in the general formula shown above assumes a value of 2 or 3. Both β- and δ-sodium disilicates (Na₂Si₂O₅.yH₂O) are particularly preferred, β-sodium disilicate being obtainable for example by the process described in International patent application WO 91/08171. δ-Sodium silicates with a modulus of 1.9 to 3.2 may be produced in accordance with Japanese patent applications JP 04/238 809 or JP 04/260 610. Substantially water-free crystalline alkali metal silicates corresponding to the above general formula, in which x is a number of 1.9 to 2.1, obtainable from amorphous alkali metal silicates as described in European patent applications EP 0 548 599, EP 0 502 325 and EP 0 425 428 may also be used. Another preferred embodiment of the detergents according to the invention is characterized by the use of a crystalline sodium layered silicate with a modulus of 2 to 3 which may be produced from sand and soda by the process according European patent application EP 0 436 835. The crystalline sodium silicates with a modulus of 1.9 to 3.5 which may be obtained by the processes according to European patents EP 0 164 552 and/or EP 0 294 753 are used in a another preferred embodiment of the detergents according to the invention. Crystalline layer silicates corresponding to formula (I) are marketed, for example, by Clariant GmbH (Germany) under the trade name Na-SKS, including for example Na-SKS-1 (Na₂Si₂₂O₄₅.xH₂O, kenyaite) Na-SKS-2 (Na₂Si₁₄O₂₉.xH₂O, magadiite), Na-SKS-3 (Na₂Si₈O₁₇.xH₂O), Na-SKS-4 (Na₂Si₄O₉.xH₂O, makatite). Of these, Na-SKS-5 (α-Na₂Si₂O₅), Na-SKS-7 (β-Na₂Si₂O₅ natrosilite), Na-SKS-9 (NaHSi₂O₅.H₂O), Na-SKS-10 (NaHSi₂O₅.3H₂O, kanemite), Na-SKS-11 (t-Na₂Si₂O₅) and Na-SKS-13 (NaHSi₂O₅), but especially Na-SKS-6 (δ-Na₂Si₂O₅), are particularly suitable. An overview of crystalline layer silicates can be found, for example, in the articles published in “Hoechst High Chem Magazin 14/1993”, pages 33-38 and in “Seifen-Öle-Fette-Wachse”, Vol. 116, No. 20/1990”, pages 805-808. Another preferred embodiment of the detergents according to the invention is characterized by the use of the granular compound of crystalline layered silicate and citrate, of crystalline layered silicate and the above-mentioned (co)polymeric polycarboxylic acid, as described for example in German patent application DE 198 19 187, or of alkali metal silicate and alkali metal carbonate, as described, for example, in International patent application WO 95/22592 or as commercially obtainable, for example, under the name of Nabion® 15.

Builders may optionally be present in the detergents according to the invention in quantities of up to 90% by weight and are preferably present in quantities of up to 75% by weight. Laundry detergents according to the invention have builder contents of, in particular, 5% by weight to 50% by weight. In hard-surface cleaning compositions, more particularly dishwasher detergents, according to the invention, the builder content is in particular between 5% by weight and 88% by weight, such compositions preferably being free from water-insoluble builders. Another preferred embodiment of the dishwasher detergents according to the invention contains 20% by weight to 40% by weight of a water-soluble organic builder, more particularly alkali metal citrate, 5% by weight to 15% by weight of alkali metal carbonate and 20% by weight to 40% by weight of alkali metal disilicate.

Additional peroxygen compounds suitable for use in detergents according to the invention include, in particular, organic per acids or peracidic salts of organic acids, such as phthalimidopercaproic acid, perbenzoic acid or salts of diperdodecanedioic acid, hydrogen peroxide and inorganic salts which release hydrogen peroxide under washing conditions, including perborate, persilicate and/or persulfate, such as caroate. The peroxygen compounds may be used in the form of powders or granules which may also be coated in known manner. If a detergent according to the invention contains additional peroxygen compounds, they are present in quantities of preferably up to 50% by weight and more preferably from 5% by weight to 30% by weight. The addition of small quantities of known bleach stabilizers, for example phosphonates, borates or metaborates and metasilicates, and magnesium salts, such as magnesium sulfate, can be useful.

Compounds which form aliphatic peroxocarboxylic acids containing preferably 1 to 10 carbon atoms and more preferably 2 to 4 carbon atoms and/or optionally substituted perbenzoic acid under perhydrolysis conditions may be used as bleach activators. Substances bearing O- and/or N-acyl groups with the number of carbon atoms mentioned and/or optionally substituted benzoyl groups are suitable. Preferred bleach activators are polyacylated alkylenediamines, more particularly tetraacetyl ethylenediamine (TAED), acylated triazine derivatives, more particularly 1,5-diacetyl-2,4-dioxohexahydro-1,3,5-triazine (DADHT), acylated glycolurils, more particularly tetraacetyl glycoluril (TAGU), N-acylimides, more particularly N-nonanoyl succinimide (NOSI), acylated phenol sulfonates, more particularly n-nonanoyl- or isononanoyl-oxybenzenesulfonate (n- or iso-NOBS), carboxylic anhydrides, more particularly phthalic anhydride, acylated polyhydric alcohols, more particularly triacetin, ethylene glycol diacetate, 2,5-diacetoxy-2,5-dihydrofuran and the enol esters known from German patent applications DE 196 16 693 and DE 196 16 767, acetylated sorbitol and mannitol and the mixtures thereof (SORMAN) described in European patent application EP 0 525 239, acylated sugar derivatives, more particularly pentaacetyl glucose (PAG), pentaacetyl fructose, tetraacetyl xylose and octaacetyl lactose, and acetylated, optionally N-alkylated glucamine and gluconolactone, and/or N-acylated lactams, for example N-benzoyl caprolactam, which are known from International patent applications WO 94/27970, WO 94/28102, WO 94128103, WO 95/00626, WO 95/14759 and WO 95/17498. The substituted hydrophilic acyl acetals known from German patent application DE 196 16 769 and the acyl lactams described in German patent application DE 196 16 770 and in International patent application WO 95114075 are also preferably used. The combinations of conventional bleach activators known from German patent application DE 44 43 177 may also be used. Bleach activators such as these are present in the usual quantities, preferably in quantities of 0.5% by weight to 10% by weight and more preferably in quantities of 1% by weight to 8% by weight, based on the detergent as a whole.

In addition to or instead of the conventional bleach activators mentioned above, the sulfonimines known from European patents EP 0 446 982 and EP 0 453 003 and/or bleach-boosting transition metal salts or transition metal complexes may also be present as so-called bleach catalysts.

Enzymes suitable for use in the detergents according to the invention in addition to the protease crucial to the invention are those from the class of lipases, cutinases, pullulanases, hemicellulases, cellulases, oxidases, laccases and peroxidases and mixtures thereof. Other proteases or amylases than the protease or amylase crucial to the invention may also be present in addition to that protease or amylase. Enzymes obtained from fungi or bacteria, such as Bacillus subtilis, Bacillus licheniformis, Streptomyces griseus, Humicola lanuginosa, Humicola insolens, Pseudomonas peudoalcaligenes, Pseudomonas cepacia and Coprinus cinereus are particularly suitable. The enzymes optionally used in addition may be adsorbed to supports and/or embedded in membrane materials to protect them against premature inactivation, as described for example in International patent applications WO 92/11347 or WO 94123005. They are present in the detergents according to the invention in quantities of preferably up to 5% by weight and, more preferably, 0.2% by weight to 2% by weight.

The detergents may additionally contain other typical detergent ingredients. These optional constituents include, in particular, enzyme stabilizers, redeposition inhibitors, dye transfer inhibitors, foam inhibitors and optical brighteners and also dyes and perfumes. To protect silverware against corrosion, dishwasher detergents according to the invention may contain silver corrosion inhibitors. In addition, a hard-surface detergent according to the invention may contain abrasive ingredients, more especially from the group consisting of silica flours, wood flours, polymer powders, chalks and glass microbeads and mixtures thereof. Abrasives are present in the dishwasher detergents according to the invention in quantities of preferably not more than 20% by weight and, more particularly, in quantities of 5% by weight to 15% by weight.

To establish a desired pH value which is not spontaneously adjusted by the mixture of the other components, the detergents according to the invention may contain system-compatible and environmentally compatible acids, more particularly citric acid, acetic acid, tartaric acid, malic acid, lactic acid, glycolic acid, succinic acid, glutaric acid and/or adipic acid and also mineral acids, more especially sulfuric acid, or bases, more especially ammonium or alkali metal hydroxides. pH regulators such as these are present in the detergents according to the invention in quantities of preferably not more than 20% by weight and, more preferably, between 1.2% by weight and 17% by weight.

Dye transfer inhibitors suitable for use in laundry detergents according to the invention include, in particular, polyvinyl pyrrolidones, polyvinyl imidazoles, polymeric N-oxides, such as poly-(vinylpyridine-N-oxide) and copolymers of vinyl pyrrolidone with vinyl imidazole.

The function of redeposition inhibitors is to keep the soil detached from the fibers suspended in the wash liquor. Suitable redeposition inhibitors are water-soluble, generally organic colloids, for example starch, glue, gelatine, salts of ether carboxylic acids or ether sulfonic acids of starch or cellulose or salts of acidic sulfuric acid esters of cellulose or starch. Water-soluble polyamides containing acidic groups are also suitable for this purpose. Other starch products than the starch derivatives mentioned above, for example aldehyde starches, may also be used. Cellulose ethers, such as carboxymethyl cellulose (sodium salt), methyl cellulose, hydroxyalkyl cellulose, and mixed ethers, such as methyl hydroxyethyl cellulose, methyl hydroxypropyl cellulose, methyl carboxymethyl cellulose and mixtures thereof, are preferably used, for example in quantities of 0.1 to 5% by weight, based on the detergent.

Laundry detergents according to the invention may contain derivatives of diaminostilbene disulfonic acid or alkali metal salts thereof as optical brighteners. Suitable optical brighteners are, for example, salts of 4,4′-bis-(2-anilino-4-morpholino-1,3,5-triazinyl-6-amino)-stilbene-2,2′-disulfonic acid or compounds of similar structure which contain a diethanolamino group, a methylamino group and anilino group or a 2-methoxyethylamino group instead of the morpholino group. Brighteners of the substituted diphenyl styryl type, for example alkali metal salts of 4,4′-bis-(2-sulfostyryl)-diphenyl, 4,4′-bis-(4-chloro-3-sulfostyryl)-diphenyl or 4-(4-chlorostyryl)-4′-(2-sulfostyryl)-diphenyl, may also be present. Mixtures of the brighteners mentioned may also be used.

Particularly where the detergents are used in washing machines, it can be of advantage to add typical foam inhibitors to them. Suitable foam inhibitors are, for example, soaps of natural or synthetic origin which have a high percentage content of C₁₈₋₂₄ fatty acids. Suitable non-surface-active foam inhibitors are, for example, organopolysiloxanes and mixtures thereof with microfine, optionally silanized, silica and also paraffins, waxes, microcrystalline waxes and mixtures thereof with silanized silica or bis-stearyl ethylenediamide. Mixtures of different foam inhibitors, for example mixtures of silicones, paraffins and waxes, may also be used with advantage. The foam inhibitors, more particularly silicone- and/or paraffin-containing foam inhibitors, are preferably fixed to a granular water-soluble or water-dispersible support. Mixtures of paraffins and bis-stearyl ethylenediamides are particularly preferred.

The production of solid detergents according to the invention does not involve any difficulties and may be carried out in known manner, for example by spray drying or granulation, the enzymes and any other heat-sensitive ingredients, for example bleaching agents, optionally being separately added at a later stage. Detergents according to the invention having a high bulk density, more particularly in the range from 650 to 950 g/l, are preferably produced by the process comprising an extrusion step which is known from European patent EP 0 486 592. Another preferred production process is the granulation process according to European patent EP 0 642 576.

To produce detergents according to the invention in the form of tablets which comprise one or more phases and are colored in one or more colors and, in particular, may consist of one layer or several layers, more particularly two layers, all the ingredients—optionally for each layer—may be mixed together in a mixer and the resulting mixture tablefted in conventional tablet presses, for example eccentric presses or rotary presses, under pressures of about 50 to 100 kN and preferably under pressures of 60 to 70 kN. In the case of multilayer tablets in particular, it can be of advantage if at least one layer is compressed in advance. n the case of multilayer tablets in particular, it can be of advantage if at least one layer is compressed in advance, preferably under pressures of 5 to 20 kN and more particularly 10 to 15 kN. Fracture-resistant tablets which still dissolve sufficiently quickly under in-use conditions are readily obtained in this way; they have fracture and flexural strengths of normally 100 to 200 N and preferably above 150 N. A tablet produced in this way preferably has a weight of 10 g to 50 g and, more particularly, 15 g to 40 g. The tablets may be of any shape, including round, oval or angular and variations thereof. Corners and edges are advantageously rounded off. Round tablets preferably have a diameter of 30 mm to 40 mm. The size of rectangular or square tablets in particular, which are mainly introduced from dispensing compartments, for example of dishwashers, is dependent on the geometry and the size of the dispensing compartment. For example, preferred embodiments have a base area of (20 to 30 mm)×(34 to 40 mm) and, more particularly, 26×36 mm or 24×38 mm.

### EXAMPLES

### Example 1

To determine washing performance, cotton fabric soiled with standardized test soils (3 soils containing blood and milk) was washed in a domestic washing machine (Miele® W 701, normal program) at 40° C. (detergent dose 76 g, water hardness 16° d, load 3.5 kg). Table 1 below shows the washing results (% reflectance at 460 nm) after different washing times as the outcome of 5× determinations averaged over all soils for a detergent V1 containing 25% by weight of zeolite NaA, 12% by weight of alkyl benzenesulfonate, 5% by weight of fatty alkyl sulfate, 1% by weight of soap, 10% by weight of nonionic surfactant, 7% by weight of TAED, 4% by weight of foam regulator granules and 2.5% by weight of enzyme granules (amylase, lipase, cellulase and S3T +V4I+V193M +L211D BLAP protease) and also 14% by weight sodium perborate monohydrate (balance to 100% by weight water, perfumes and sodium sulfate); for a detergent V2 which had the same composition as V1 but, instead of sodium perborate, contained uncoated sodium percarbonate in the same quantity in terms of available oxygen and for a detergent M1 which had the same composition as V1 but, instead of sodium perborate, contained sodium percarbonate coated with sodium sulfate/silicate (percarbonate ECOX-C) in the same quantity in terms of available oxygen.

TABLE 1
Washing results (reflectance in %)

| | Washing result after | | |
|---|---|---|---|
| Detergent | 10 mins. | 20 mins. | 50 mins. |
| V1 | 28.4 | 33.5 | 48.0 |
| C2 | 28.5 | 34.7 | 47.1 |
| M1 | 29.5 | 36.1 | 51.8 |

It can be seen that the detergent according to the invention is distinctly superior in its performance to the detergents containing a another bleaching agent.

### Example 2

Example 1 was repeated, the washing temperature being increased to 60° C. The washing results obtained are set out in Table 2 below.

TABLE 2
Washing results (reflectance in %)

| | Washing result after | | |
|---|---|---|---|
| Detergent | 10 mins. | 20 mins. | 50 mins. |
| V1 | 27.6 | 36.8 | 48.8 |
| V2 | 29.2 | 39.8 | 52.6 |
| M1 | 30.8 | 41.0 | 53.1 |

It can be seen that the detergent according to the invention is again distinctly superior in its performance to the detergents containing a another bleaching agent.

1. A particulate detergent or cleaner, comprising a mutant subtilisin protease in which one or more amino acids in a wild-type protease at BLAP positions 3, 4, 99, 188, 193, 199 or 211 is replaced by another amino acid, and a particulate alkali metal percarbonate with a coating comprising one or more of alkaline earth metal sulfate, alkali metal sulfate, alkali metal silicate, alkaline earth metal halide, alkali metal halide, alkali metal carbonate, alkali metal hydrogen carbonate, alkali metal phosphate, alkali metal borate, alkali metal perborate, boric acid, partly hydrated alumosilicate, carboxylic acid, dicarboxylic acid, or polymer of unsaturated carboxylic and/or dicarboxylic acids.

2. The detergent or cleaner of claim 1, wherein the coating comprises alkali metal sulfate, alkali metal silicate, or both.

3. The detergent or cleaner of claim 1, comprising 3% to 30% by weight of coated alkali metal percarbonate.

4. The detergent or cleaner of claim 3, comprising 7% to 25% by weight of coated alkali metal percarbonate.

5. The detergent or cleaner of claim 2, comprising 3% to 30% by weight of coated alkali metal percarbonate.

6. The detergent or cleaner of claim 5, comprising 7% to 25% by weight of coated alkali metal percarbonate.

7. The detergent or cleaner of claim 1, having a proteolytic activity of 100 PU/g to 10,000 PU/g.

8. The detergent or cleaner of claim 7, having a proteolytic activity of 300 PU/g to 8,000 PU/g.

9. The detergent or cleaner of claim 2, having a proteolytic activity of 100 PU/g to 10,000 PU/g.

10. The detergent or cleaner of claim 3, having a proteolytic activity of 100 PU/g to 10,000 PU/g.

11. The detergent or cleaner of claim 10; having a proteolytic activity of 300 PU/g to 8,000 PU/g.

12. The detergent or cleaner of claim 1, wherein the mutant protease has one or more of the amino acid exchanges S3T, V4I, R99G, R99A, R99S, A188P, V193M or V199I.

13. The detergent or cleaner of claim 2, wherein the mutant protease has one or more of the amino acid exchanges S3T, V4I, R99G, R99A, R99S, A188P, V193M or V199I.

14. The detergent or cleaner of claim 3, wherein the mutant protease has one or more of the amino acid exchanges S3T, V4I, R99G, R99A, R99S, A188P, V193M or V199I.

15. The detergent or cleaner of claim 7, wherein the mutant protease has one or more of the amino acid exchanges S3T, V4I, R99G, R99A, R99S, A188P, V193M or V199I.

16. The detergent or cleaner of claim 8, wherein the mutant protease has one or more of the amino acid exchanges S3T, V4I, R99G, R99A, R99S, A188P, V193M or V199I.

17. The detergent or cleaner of claim 1, wherein the particulate alkali metal percarbonate has a weight ratio of coating to percarbonate of from 1:500 to 1:2.

18. The detergent or cleaner of claim 17, wherein the particulate alkali metal percarbonate has a weight ratio of coating to percarbonate of from 1:200 to 1:5.

19. A method of cleaning protein-containing soils from textiles or hard surfaces, comprising contacting a textile or hard surface in need of protein-containing soil removal with a cleaning-effective amount of a particulate detergent or cleaner or solution thereof comprising a mutant subtilisin protease in which one or more amino acids in a wild-type protease at BLAP positions 3, 4, 99, 188, 193, 199 or 211 is replaced by another amino acid, and a particulate alkali metal percarbonate with a coating comprising one or more of alkaline earth metal sulfate, alkali metal sulfate, alkali metal silicate, alkaline earth metal halide, alkali metal halide, alkali metal carbonate, alkali metal hydrogen carbonate, alkali metal phosphate, alkali metal borate, alkali metal perborate, boric acid, partly hydrated alumosilicate, carboxylic acid, dicarboxylic acid, or polymer of unsaturated carboxylic and/or dicarboxylic acids.

20. The method of claim 19, wherein the coating comprises alkali metal sulfate, alkali metal silicate, or both.

21. The method of claim 19, wherein the detergent or cleaner comprises 3% to 30% by weight of coated alkali metal percarbonate.

22. The method of claim 21, wherein the detergent or cleaner comprises 7% to 25% by weight of coated alkali metal percarbonate.

23. The method of claim 19, wherein the detergent or cleaner has a proteolytic activity of 100 PU/g to 10,000 PU/g.

24. The method of claim 23, wherein the detergent or cleaner has a proteolytic activity of 300 PU/g to 8,000 PU/g.

25. The method of claim 19, wherein the mutant protease has one or more of the amino acid exchanges S3T, V4I, R99G, R99A, R99S, A188P, V193M or V199I.

26. The method of claim 19, wherein the particulate alkali metal percarbonate has a weight ratio of coating to percarbonate of from 1:500 to 1:2.
